(19) United States
(12) Patent Application Publication
(10) Pub. No.: US 2020/0375289 A1
(43) Pub. Date: Dec. 3, 2020

(54) SYSTEM FOR CONTROLLING WEARABLE MEDIA

(71) Applicant: The North Face Apparel Corp., Wilmington, DE (US)

(72) Inventors: Dhruv Agarwal, Greensboro, NC (US); Karen Reuther, Rye, NH (US); Hannah LeClair, Newburyport, MA (US); Emily Alati, Portsmouth, NH (US)

(21) Appl. No.: 16/606,793

(22) PCT Filed: May 3, 2018
(86) PCT No.: PCT/US2018/030943

§ 371 Date: Oct. 21, 2019

Related U.S. Application Data
(60) Provisional application No. 62/500,819, filed on May 3, 2017.

(51) Int. Cl. A41D 27/08; A41D 1/00; A41D 13/005; H04W 12/06; H04W 76/10

(52) U.S. Cl. CPC A41D 27/08; A41D 1/002; H04W 76/10; H04W 12/06; A41D 13/0051

(57) ABSTRACT

A system for controlling wearable media, the system comprising an article of wearable media, the article including at least one portion that is configured to change from a first configuration to a second configuration in response to a stimulus; a stimulator coupled to the at least one portion and adapted to selectively apply a stimulus upon receiving an activation command; a controller including a processor, a memory and an input/output device, the processor configured to execute instructions including communicating with the wearable media, the controller being adapted to selectively communicate with the stimulator to send the activation command to change the at least one portion from the first configuration to the second configuration.

### TECHNICAL FIELD

The present disclosure relates to a system for controlling wearable media. In particular, the disclosure relates to a system that includes a controller that communicates an activation command to an article of wearable media that causes a portion of the article to change from a first configuration to a second configuration, where the change includes changing at least one of a color and a shape of the portion of the article.

### BACKGROUND

Consumers want customized garments and accessories designed according to their specific preferences for style, color, and fit. Consumer preferences vary widely from one person to the next and can change over time, complicating customization efforts of garment manufacturers. Hand-tailored garments are highly customized for the individual. Hand-tailored garments require specialized skill to make and command a price premium. In stark contrast to tailored garments, minimally customized garments, such as ready-to-wear, serve a large proportion of the market. Most garments on the market today have complex supply chains making it difficult for manufacturers to react quickly to changing consumer preferences. The challenge of customization directly related to the state of garment technology, the essentials of which have not changed significantly since people have been wearing tailored garments. Whether hand-tailored or mass-produced, the fundamentals of garment production are the same: panels of fabric are cut and sewn or otherwise joined together and other components, such as zippers, hems, buttons, etc., attached to the sewn fabric panels. Garment production is still complex and labor intensive.

Color change and shape change fibers have been developed that can be used to form garments, accessories, hair extensions and other wearable articles. The ability to perform shape and color change offers greater customization capability allowing the article to be reconfigured for purposes of ornamentation, advertisement, or performance.

### SUMMARY

An embodiment of the present disclosure includes a system for controlling wearable media, the system comprising an article of wearable media, the article including at least one portion that is configured to change from a first configuration to a second configuration in response to a stimulus; a stimulator coupled to the at least one portion and adapted to selectively apply a stimulus upon receiving an activation command; a controller including a processor, a memory and an input/output device, the processor configured to execute instructions including communicating with the wearable media, the controller being adapted to selectively communicate with the stimulator to send the activation command to change the at least one portion from the first configuration to the second configuration.

According to a further example, a system for controlling wearable media comprises an article of wearable media, the article including at least one portion that is constructed from at least one of a color change material and a shape memory material, wherein the at least one portion is configured to change from a first configuration to a second configuration in response to a stimulus; a stimulator coupled to the at least one portion and adapted to selectively apply a stimulus upon receiving an activation command; a controller including a processor, a memory and an input/output device, the processor configured to execute instructions including communicating with the wearable media, the controller being adapted to selectively communicate with the stimulator to send the activation command to change the at least one portion from the first configuration to the second configuration; a sensor in communication with the controller, wherein the controller is configured to send the activation command based on a signal from at least one of the input/output device and the sensor.

According to another example, a network device includes a processor, an input/output device coupled to the processor, and a memory coupled with the processor, the memory comprising executable instructions that when executed by the processor cause the process to effectuate operations comprising creating a data store including at least one activation command configured to change at least a portion of wearable media from a first configuration to a second configuration; providing an authentication module for at least one of a user, a third party user, and a third party provider to provide selected access to the at least one activation command in the data store.

### BRIEF DESCRIPTION OF THE DRAWINGS

FIG. 1 is a representation of a system for controlling wearable media enlarged to show details of a stimulator on an article of wearable media in communication with a controller.

FIG. 2A is a representation of a system for controlling wearable media depicting an article of wearable media in a first configuration.

FIG. 2B is a representation of a system for controlling wearable media depicting communication of an activation command to change the configuration of the article of wearable media to a second configuration.

FIG. 3A is a representation of a system for controlling wearable media depicting a user having wearable media in a first configuration and a third party user having wearable media in a second configuration.

FIG. 3B is representation of a system for controlling wearable media depicting reconfiguring of the user's wearable media to a second configuration that matches the third party user's wearable media.

FIG. 4A is a depiction of wearable media according to an example having a first configuration with a first shape with short sleeves and a second configuration with a second shape with long sleeves.

FIG. 4B is a depiction of wearable media according to an example having a first configuration in the form of shorts and a second configuration where the legs of the shorts are lengthened to form pants.

FIG. 5 is representation of wearable media having a first configuration where the fabric of the article lies flat and a second configuration where the fabric has reshaped in an accordion fashion to trap air between the article and the user.

FIG. 6 is a representation showing a wearable media in a first configuration and a second configuration where a portion of the article of wearable media behind a knee region has expanded and stiffened to provide support.

FIG. 7 is a representation of a system for controlling wearable media depicting a first configuration and a second configuration where the wearable media is reconfigured to provide greater heat transfer away from the user.

FIG. 8 is a representation of wearable media having a first configuration where multiple colors are displayed to form a camouflage and a second configuration where a single color is displayed.

FIG. 9 is a flow diagram depicting an example operation of a system for controlling wearable media.

FIG. 10 is a schematic representation of one example of a system for controlling wearable media.

### DETAILED DESCRIPTION OF EMBODIMENTS

As described more completely below, a system 100 according to the disclosure interacts with a wearable article, such as a garment or an accessory that has at least a portion constructed from a material that has the ability to change its configuration. A configuration change includes but is not limited to changes in color, shape, or size. For simplicity, such articles will be collectively referred to as wearable media. The wearable media's ability to change configuration offers the ability to customize its appearance and/or performance. For example, color change can be used to alter the appearance of the wearable media on demand or in response to outside stimulus. Color change may also be used as a performance enhancement for example by changing from a dark color to a lighter or reflective color to reduce the effects of sunlight or otherwise help control body temperature. Color change may also be used for personal safety. For example, a more visible color may be selected to allow the user to stand out from their surroundings if they are lost or are in need of aid. Likewise, shape changes can be used to improve fit, provide support, add durability or protection, and control the thermal conductivity of the material. As described more completely below, these changes in configuration may be controlled by system 100. System 100 is a system for controlling wearable media W that has the ability to change from a first configuration to at least a second configuration. System 100 may be used by a user that owns one or more articles of wearable media to control their article(s) independently to customize the appearance of each article that they own. When one user has multiple articles of wearable media, system 100 may be used to coordinate configuration changes amongst multiple articles worn by a user. In another example, system 100 communicates with multiple users that have registered or otherwise indicated their desire to have their articles coordinated as a group allowing system to control all registered wearable media.

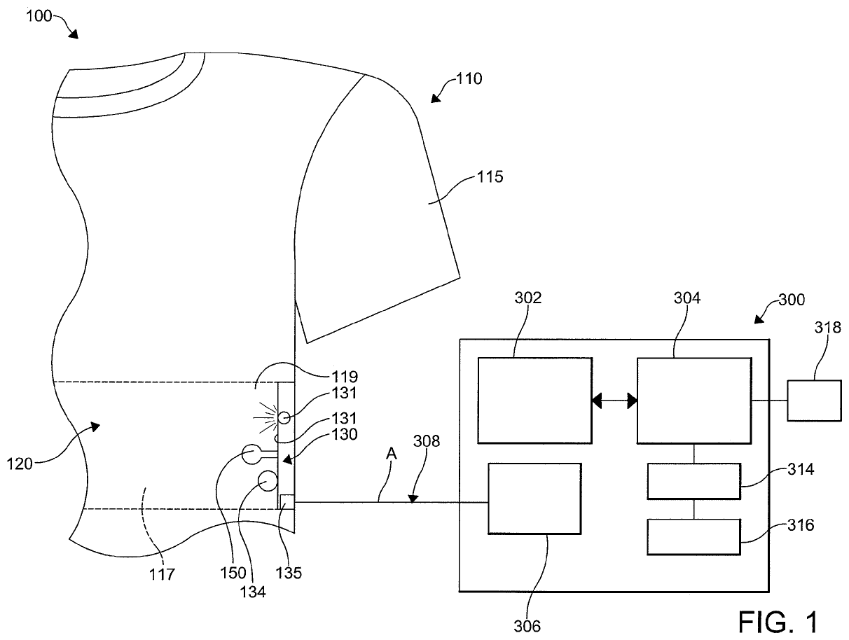

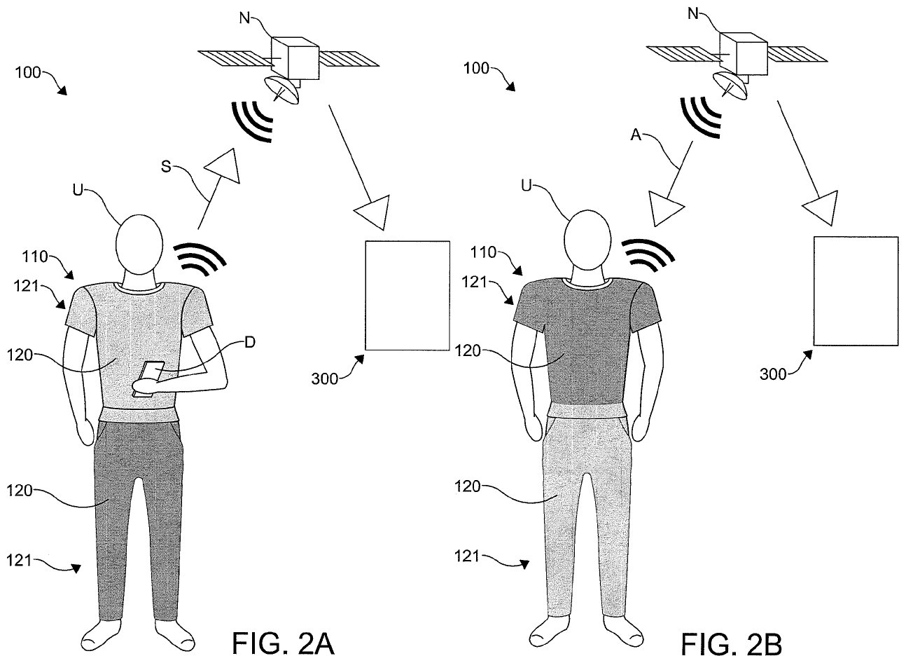

Referring to FIGS. 1 and 2, examples of the present disclosure include a system 100 in communication with wearable media 110. Wearable media 110 may include an article 115 worn by a user U including but not limited to a garment, including but not limited to a shirt, pant, short, coat, jacket, hat, foot wear, or costume. Wearable media 110 may also include an accessory including but not limited to jewelry, a wrist band, a head band, a scarf, a decoration that is affixed to a garment or the user, such as a swatch, a bow, a handkerchief, a pocket stay, a wig, or hair segments or extensions. Article 115 includes at least a portion 120 that can be reconfigured. For example, portion 120 may include a first configuration 121 and at least a second configuration 122. The first configuration 121 may be a default configuration for portion 120 or configuration that it assumes when no stimulus is applied. First configuration 121 may also be a configuration that has been selected by the user or preselected by the manufacturer. The second configuration 122 is generally different from the first configuration 121 such as a different color, shape or other aspect of the configuration of the portion 120. It will be understood that portion 120 may encompass any amount of the article including the whole article 115. Portion 120 may be constructed as part of the article 115 or attached to the article 115 after it is constructed. To that end, portion 120 may be sold separately and attached to an existing article 115.

The portion 120 of article 115 is a material that can be worn by a user. The portion may be a fiber 117 or a fabric 119 that changes configuration in response to a stimulus controlled by system 100 as described more completely below. The fabric may be formed using any suitable textile processing technique and include woven and non-woven fabrics. Stimulus may include a mechanical, thermal, electrical, magnetic, or visual (light) stimulus or combinations thereof.

For example, a color change portion 120 may include a fiber or fabric dyed with an electrophoretic or electronic ink that reacts to an electrical stimulus to selectively change color. A thermochromatic ink or dye may change color in response to thermal stimuli such as the application or withdrawal of heat or other temperature change. In one example, an electrical current is used to generate heat to activate selected colors. A visual stimulus may include light. For example, photonic bandgap fibers that have the ability to change color when illuminated with ambient or transmitted white light may be woven into textile products to form at least a portion 120 of article 115. Mechanical stimuli may include pressure that causes different light refraction or acoustic input to effect a color change in appropriate materials.

In addition the same stimuli may be used to cause a configuration change that includes a change in shape of portion 120. For example, shape memory based materials and alloys may be used to reconfigure an article from a first configuration to a second configuration where the two configurations are physically different from each other.

In one example, fiber 117 or fabric 119 includes a shape memory polymer or other polymer smart material. This material may be induced to a deformed state through application of heat or a temperature change. One example of a fiber that can be used as a shape memory material is Nitinol. Nitinol combines two closely related unique characteristics: shape memory and superelasticity. Shape memory gives Nitinol the ability to be deformed at one temperature, and then return to its original shape when being heated to its transformation temperature. This effect is caused by the material changing from its low temperature monoclinic martensitic structure to the high temperature cubic austenitic structure. Transformation temperatures in finished Nitinol wire range from −15° C. to +22° C., depending on the grade of Nitinol used.

U.S. Pat. No. 8,187,984, which is incorporated herein by reference, describes another shape change material formed by applying coatings having different thermal expansion properties that cause the textile to change its shape in response to changes in ambient temperature. In particular, the textile fabric can include one or more regions of a second coating material overlying one or more regions of the first coating material, the first coating material together with the second coating material forming a bi-component coating at the smooth surface of the textile fabric. The second coating material may be chemically and/or physically bonded to the first coating material. The second coating material is disposed on a first surface of the first coating material opposite the smooth surface of the textile fabric. The first coating material and the second coating material exhibit differential thermal expansion to cause a change in a three dimensional configuration of the textile fabric in response to change in temperature. The first coating material and the second coating material exhibit differential thermal expansion in response to change in temperature over a predetermined temperature range. In some cases, the predetermined temperature range is between about −40° F. and about 140° F. In some examples, the predetermined temperature range is between about 50° F. and about 100° F. In other examples, the predetermined temperature range is between about −40° F. and about 60° F., e.g., between about −20° F. and about 40° F.

The first coating material may be a polymer, such as polyurethane. The polymer exhibits volume change by crystallization. The polymer is configured to crystallize at a temperature of between about −40° F. and about 100° F. For example, in some cases, the polymer is configured to crystallize at a temperature of between about 50° F. and about 100° F., e.g., between about 60° F. and about 98° F., e.g., between about 69° F. and about 73° F. In another example, the polymer is configured to crystallize at a temperature of between about −40° F. and about 60° F., e.g., between about −20° F. and about 40° F.

The second coating material comprises polymer, selected, e.g., from the group consisting of: polyurethanes, silicones, and acrylates. In some embodiments, one or more regions of the second coating material are disposed on the smooth surface of the textile fabric, and the first coating material overlies one or more regions of the second coating material. In some cases, the first coating material is arranged in overlapping relationship with the second coating material such that at least a portion of the first coating material contacts the smooth surface of the textile fabric. The textile fabric includes one or more regions of a second material disposed in side-by-side relationship with the first coating material on the smooth surface of fabric. The textile fabric has a circular knit construction, warp knit construction, and/or woven construction. In any of the above knit constructions, elastic yarn may be added (e.g., spandex such as Lycra® or Lycra® T-400) to, e.g., the stitch yarn. The spandex yarn can include, for example, bare spandex yarn, core spun yarn, wrap yarn, and/or air entangled yarn. The circular knit construction is formed in single jersey construction, double knit construction, or terry sinker loop construction. The terry sinker loop is formed in plaited construction. The terry sinker loop is formed in reverse plaited construction. The terry sinker loop may be raised by napping or may remain in an un-napped condition. The first coating material is disposed in a plurality of predetermined discrete regions on the smooth surface of the textile fabric. The plurality of predetermined discrete regions may be in the form of discrete dots. The first coating material covers between about 5% and about 80% of the surface area of the smooth surface.

In other examples, the shape change is triggered by an electric or magnetic field, light, or chemical solution. Representative shape-memory polymers in this category include polyurethanes, polyurethanes with ionic or mesogenic components made by prepolymer method. Other block copolymers also show the shape-memory effect, such as, block copolymer of polyethylene terephthalate (PET) and polyethyleneoxide (PEO), block copolymers containing polystyrene and poly(1,4-butadiene), and an ABA triblock copolymer made from poly(2-methyl-2-oxazoline) and polytetrahydrofuran. A linear, amorphous polynorbornene (Norsorex, developed by CdF Chemie/Nippon Zeon) or organic-inorganic hybrid polymers consisting of polynorbornene units that are partially substituted by polyhedral oligosilsesquioxane (POSS) also have shape-memory effect. Light-activated shape-memory polymers (LASMP) use processes of photo-crosslinking and photo-cleaving to change a glass transition. Photo-crosslinking is achieved by using one wavelength of light, while a second wavelength of light reversibly cleaves the photo-crosslinked bonds. The effect achieved is that the material may be reversibly switched between an elastomer and a rigid polymer. Light does not change the temperature, only the cross-linking density within the material. For example, polymers containing cinnamic groups can be fixed into predetermined shapes by UV light illumination (>260 nm) and then recover their original shape when exposed to UV light of a different wavelength (<260 nm). Examples of photoresponsive switches include cinnamic acid and cinnamylidene acetic acid.

Electrically stimulated shape change materials change shape in response to an electrical current, and may include smart material composites with conductive elements. The conductive elements may include carbon fibers, nanotubes, or particles, such as carbon black; nickel powder and the like. In one example, a multi-walled carbon nanotube is mixed in a solvent of nitric acid and sulfuric acid. Another technique involves the use of surface-modified super-paramagnetic nanoparticles. When introduced into the polymer matrix, remote actuation of shape transitions is possible. An example of this involves the use of oligo (e-caprolactone)dimethacrylate/butyl acrylate composite with between 2 and 12% magnetite nanoparticles). Shape memory fibers may be formed into fabrics used to construct a portion 120 of article 115 or an entire article 115. These fabrics may be woven or non-woven and formed through techniques used in the textile industry or specialized techniques developed for shape memory materials. For example, U.S. Pat. No. 5,128,197 describes one shape memory specific technique for forming a fabric from shape memory material. It will be understood that the examples of materials, described herein, that can be used to form a fiber 117 or fabric 119 having at least a first configuration and a second configuration are not limiting.

According to the disclosure, system 100 an article 115 of wearable media 110 where at least a portion 120 of article 115 is adapted to have a first configuration and a second configuration. The portion 120 adopts a second configuration 122 in response to a trigger or stimulus S. The trigger or stimulus S may be provided by a stimulator 130 that is in communication with the portion 120 to provide at least one of the various stimuli discussed above as required for the type of material used to form portion 120. For example, stimulator 130 may include an electrical contact 131 to apply an electrical or magnetic field to portion 120 or to generate heat within portion 120 to effect a desired configuration change. Alternatively, stimulator 130 may include a light source 132 to selectively illuminate portion 120 to effect a configuration change, such as a color change. Stimulator 130 may alternatively include an actuator 134 to mechanically stimulate portion 120. Actuator 134 may be any suitable device for providing mechanical stimulation including but not limited to an acoustic wave generator or force applicator.

Stimulator 130 includes a communications channel 135 capable of at least receiving a signal such that stimulator 130 may be activated on a selected basis to effect a change in the configuration of portion 120. Communications channel 135 may include a wired or wireless connection. In a simple application communication channel 135 may simply include a switch that receives input from a user U to close or open a circuit to activate/deactivate stimulator 130 and effect a change from a first configuration 121 to a second configuration 122. According to another example, communications channel 135 includes a wired or wireless connection that receives a signal S configured to control operation of stimulator 130 to effect at least a change from a first configuration 121 to a second configuration 122. This signal may be referred to as an activation command A herein and described more completely below.

System 100 includes a controller, generally indicated by the number 300, that communicates with the article 115 to send an activation command A to change the portion 120 from at least a first configuration 121 to a second configuration 122 or vice versa. It will be understood that additional configurations may be achieved beyond the first and second configurations and activated by controller 300. The examples discussed herein should not be considered limiting. Controller 300 is in communication with stimulator 130, for example, through a wired or wireless connection with communications channel 135. To that end, controller 300 may be provided on article 115 or be located remote from article 115.

In one example, controller 300 may comprise a processor 302 and a memory 304 coupled to processor 302. Memory 304 may contain executable instructions that, when executed by processor 302, cause processor 302 to effectuate operations associated with changing the configuration of a portion 120 of article 115. Controller 300 may be a standalone device or provided as a network device (FIGS. 1A,1B) within a communications network N. As evident from the description herein, controller 300 is not to be construed as software per se.

In addition to processor 302 and memory 304, controller 300 may include an input/output system 306. Processor 302, memory 304, and input/output system 306 may be coupled together to allow communications between them. Each portion of controller 300 may comprise circuitry for performing functions associated with each respective portion. Thus, each portion may comprise hardware, or a combination of hardware and software. Accordingly, each portion of controller 300 is not to be construed as software per se. Input/output system 306 may be capable of receiving or providing information from or to a communications device or other network entities configured for telecommunications. For example input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with controller 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof. Bluetooth, infrared, NFC, and Zigbee are generally considered short range (e.g., few centimeters to 20 meters). WiFi is considered medium range (e.g., approximately 100 meters).

Input/output system 306 of controller 300 also may contain a communication connection 308 that allows controller 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, radio frequency (RF), infrared (IR), or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of controller 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to change the configuration of a portion 120 of an article 115 from a first configuration 121 to a second configuration 122 or vice versa.

The memory 314 of controller 300 may store one or more configurations for portion 120. In an example where the first configuration 121 of portion 120 is a default configuration i.e. no stimulus is required to assume this configuration, memory may store an activation command A that defines at least one second configuration 122. The activation command A may include one or a combination of stimuli to effect the second configuration 122. For example, second configuration 122 may include a color change and a shape change requiring application of a light stimulus to effect the color change and an electrical stimulus to effect the shape change. Activation command A in memory 314 associated with second configuration 122 would include a signal that activates stimulator 130 to provide these stimuli simultaneously or in sequence to change portion 120 to the selected configuration. Memory 314 may include plural configurations and corresponding activation commands A for each to provide multiple configurations for wearable media 110.

To that end, controller 300 may selectively communicate with article 115 via communications channel 135 in stimulator 130. An activation command A may be obtained from memory 314 and controller 300 may communicate an activation command A to activate stimulator 130 to provide the stimulus needed to effect the desired configuration change. The configuration change may be simple such as a change from a first color to a second color, or from a first shape to a second shape. Alternatively, the configuration change may be complex and involve a series of configuration changes. Stimulator 130 may be connected to one or more portions 120 and control of such portions 120 may be performed in unison to create an overall configuration change or individual portions 120 may be individually controlled independently change the configuration of portions 120.

The fabric 119 can any type of textile fabric suitable for garments or accessories and that either alone or when combined with the layer provides suitable flexibility and edge stability for the purpose of garment or accessory. Accordingly, the fabric 119 can be a woven fabric, knit fabric, a nonwoven fabric, a laminate, and/or any combination thereof. In one example, the fabric 119 is a woven fabric having a plurality of warp yarns and a plurality of weft yarns interwoven with the plurality of warp yarns to define the woven fabric. In this example, the yarns of fabric 119 include fibers 117 capable of changing from at least a first configuration 121 to a second configuration 122 as described above. In other examples, fabric 119 is coated, dyed or otherwise treated with a material that allows portion 120 to change configuration.

In a woven fabric example, any type of woven construction could be used, such as a plain weave, satin/sateen, twill, basket weave, oxford, basket weave, rib weave, or any other suitable woven construction. Woven fabrics forming the portion 120 may include synthetic yarns, natural yarns or blended yarns, singled end yarns, or plied yarns. The yarns for a woven fabric can use yarns with a range of yarn counts suitable for garments or accessories, for example, between about 6 Ne to about 120 Ne. If continuous multifilament yarns form the garment panel, the count range from 10 denier up to about 250 denier

In another example, fabric is a knit fabric. Knit fabrics may be a weft knits, such as single jersey knit fabric, a double knit, rib knit, or any other type of weft knitted fabric. The knit fabrics may have a combination of knit constructions to improve edge stability and maintain flexibility. The knit fabric may alternatively be a warp knit, such as a tricot or Rachel warp knitted fabric. Yarns used in the knit fabric, whether weft knit or warp knits, can have a range of yarn counts. For instance, knit yams can have a count in a range between about 6 Ne to about 120 Ne or the equivalent denier if continuous filaments are used.

The fabric 119 when woven or knit can be formed from any number of yarn types, such a spun yarns or continuous filament yarns. Spun yarns may include natural fibers, synthetic fibers, or blends of natural and synthetic fibers. Natural fibers include cotton, wool, bamboo, flax, hemp, or others. Synthetic fibers may include polyethylene terephthalate (PET), polyolefin, polyamide 6, polyamide 6,6, polylactic acid (PLA) fibers, viscose rayon, acrylic, or other fiber types, such a flame resistant fibers as needed. Suitable thermoplastic synthetic staple fibers may be mono-component or bi-component type fibers. A variety of yarn spinning types can be used, such as ring spun, open end, air-jet, compact spinning, and the like. Continuous filaments yarns may include either or both mono-component or bicomponent filaments types. Continuous filament yarns can be polyethylene terephthalate, polyolefin, and/or polyamide 6, polyamide 6,6, polylactic acid filaments.

In another example, the fabric 119 may also be a nonwoven fabric. Suitable nonwoven fabrics include melt-spun nonwovens, such as spunbond and meltblown materials or other structures. A meltspun nonwoven can include a single spunbond layer, multiple spunbond layers, a single meltblown layer, multiple meltblown layers, or multiple layers of spunbond and meltblown materials. Meltspun nonwovens can from with polyethylene terephthalate, polyolefin, and/or polyamide 6, polyamide 6,6, or polylactic acid polymers. Alternatively, the nonwoven fabrics can be carded or airlaid materials that are bonded thermally, chemically, and/or mechanically, e.g. via needles or stitch bonding. Suitable fibers for carded or airlaid materials include PET, cotton, and/or viscose fibers.

The fabric 119 could also be laminate of a woven and nonwoven fabric, a knit and nonwoven fabric, or even a woven and knit fabric. The textile fabric may also include a number of functional finishes, coatings, or other treatments that enhance functionality. For instance, the textile fabric can include anti-bacterial agents, coatings, flame retardant coatings, and the like.

The optional layer can be a finish, coating, fabric, film, or membrane disposed on one side of fabric 119 and/or textile laminate when present.

In accordance with another embodiment of the present disclosure, portion 120 may be one or more layers of a film or other preformed panel structure. Accordingly, it should be appreciated that the flexible material can be any material or structure that is substantially flexible, such as materials that can be easily bent by a person in use.

With reference to FIG. 2, system 100 may further include a sensor 150. Sensor 150 is in communication with controller 300. Sensor 150 may be used to monitor or detect a condition of the user U or an outside condition. For example, sensor 150 may be used to monitor the health or well-being of a user by monitoring heart rate, body temperature, respiration, or other vital information. Alternatively or in addition to monitoring the user, the sensor 150 may monitor an external condition, such as, temperature, humidity, altitude, geographic location, rate of movement, relative position of the user to landmarks or other external object. These examples should not be considered limiting. Sensor 150 may be incorporated into the article 115, attached to the article 115 or separate from the article 115. Sensor 150 may be a dedicated sensor or leveraged from a user device D with suitable capabilities, such as a smart phone, personal digital assistant, sleep monitor, health monitor, heart rate monitor, pulseox monitor, and the like. For example, system 100 may communicate with and access a microphone in a smart phone to monitor user's respiration such that the smart phone is the sensor 150. In another example, sensor 150 may include a position system within a smart device used to locate a user's location and access an appropriate data feed to obtain external condition information including but not limited to atmospheric conditions, such as, temperature, air pressure, wind speeds, pollen levels, ozone action alerts, humidity, and weather conditions. Communication between sensor 150 and controller 300 may be wired or wireless as described in connection with controller 300.

Sensor 150 may be used to effect a configuration change based on sensed information. The configuration change may be made to assist the user in protecting themselves from outside elements or help regulate internal conditions, such as, body temperature, perspiration and the like. With respect to outside elements, such configuration changes may include a configuration change to extend a mask or hood in response to pollen, chemicals, weather conditions or reduction in body temperature. Similar configuration changes including but not limited to lengthening or shortening of the garment or portions thereof, such as sleeves, legs, collars, etc; opening and closing of pores in the garment; or reconfiguration of the garment to make it more or less insulative or protective may be effected in response to sensed conditions or through a direct user request.

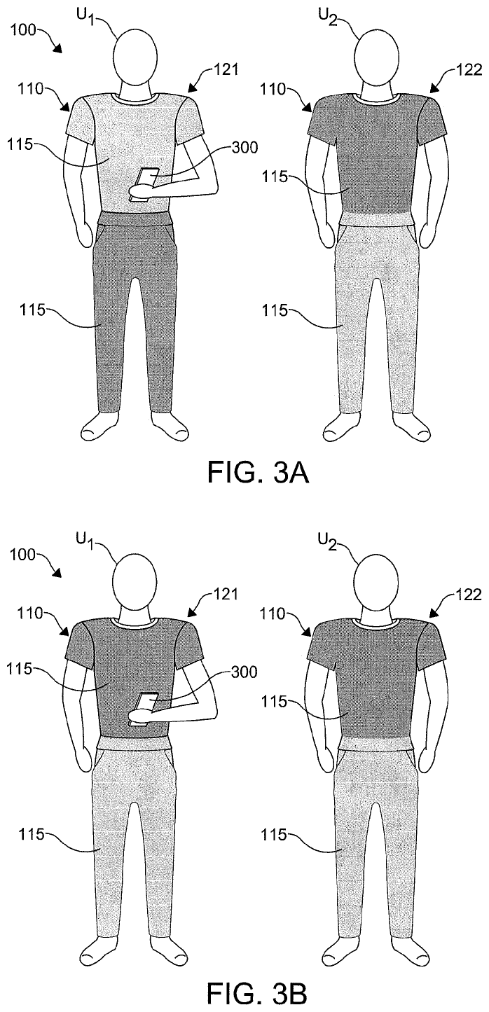

With reference to FIGS. 3A and 3B, on example is shown where sensor 150 may monitor temperature including but not limited to body temperature or ambient temperature. Article 115 may have a first configuration 121 that leaves portions of the user exposed such as a short sleeve shirt (FIG. 3A) or shorts (FIG. 3B). Upon detecting a drop in temperature via sensor 150, controller 300 may issue an activation command to change portion 120 to a second configuration that covers more of the user. For example, a transformation of short sleeve shirt to a long sleeve shirt (FIG. 3A) or transformation from shorts to pants (FIG. 3B). Such changes may be effected manually by the user providing an activation command A via controller 300 as discussed in previous examples. Likewise, controller 300 may transform article 115 from a more covering configuration to a less covering configuration in response to an increase in temperature detected by sensor 150.

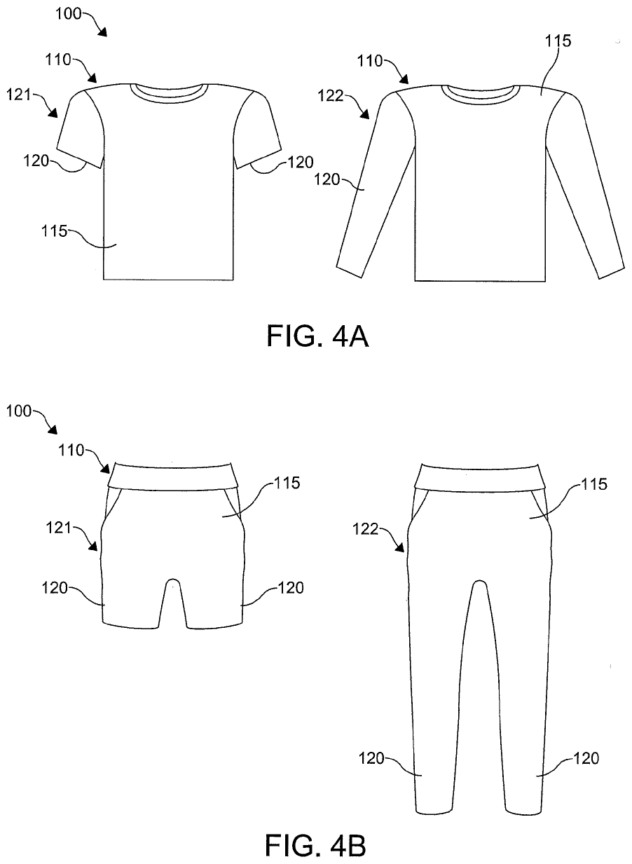

FIG. 4 shows another example, where the shape change material changes the configuration of article 115 to make it more or less insulative. For example, if sensor 150 detects a drop in outdoor temperature, controller 300 may change the shape of portion 120 to a more insulative shape to help the user retain its body temperature. Alternatively, if sensor 150 detects an increase in temperature, controller 300 may send an activation command A that causes the article 115 to effect a configuration that helps transfer heat from the user faster. These changes could include shortening or lengthening an article, as discussed above, or changing its configuration to trap more air between the article and the user's skin, such as a waffle configuration, to insulate or provide an extended surface E to transfer heat away from the user. With reference to FIG. 4, controller 300 changes article 115 from a first configuration 121 that lies flat against the user to a second configuration 122 with an accordion shape to trap air between article 115 and user making the article 115 more insulative.

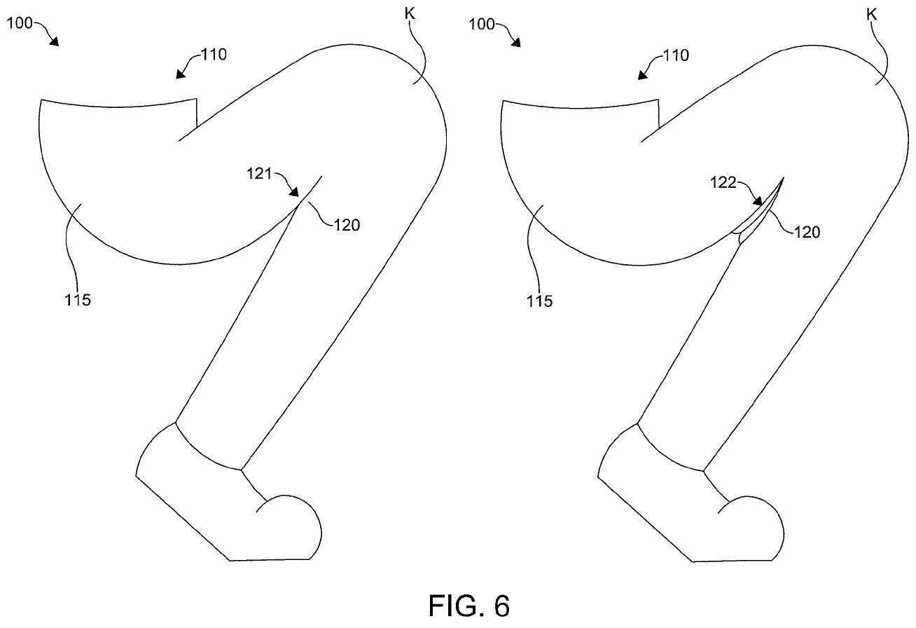

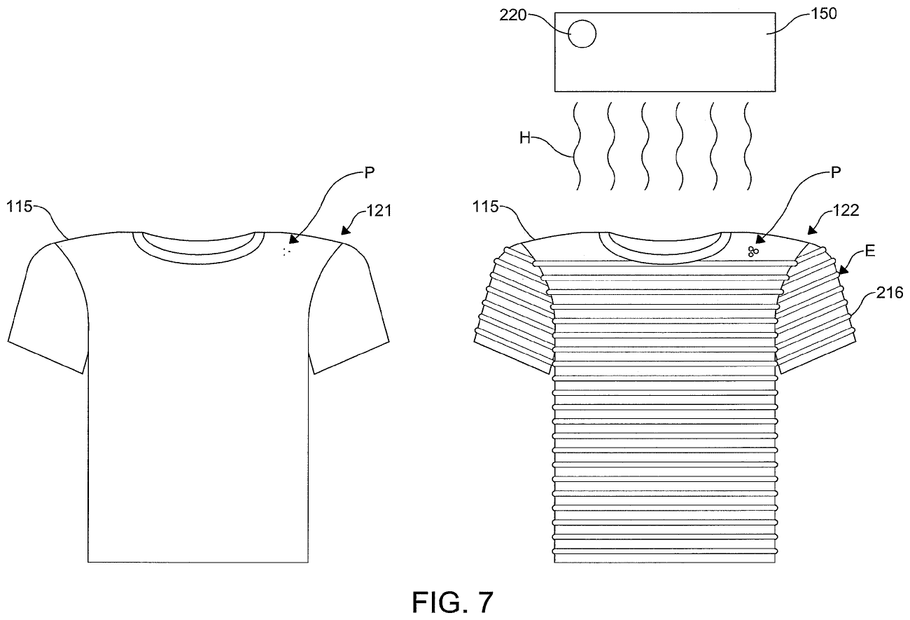

In FIG. 6, an example is shown with an article 115 that lies flat against a user with closed pores in a first configuration 121. With increased temperature or heat H, article 115 assumes a second configuration with at least one of open pores P or an extended surface E to improve heat transfer away from user. Extended surface E may be any known shape that increases the available surface area for heat transfer including but not limited to pins, fins, or ribs 216 (shown). As discussed, at least one second configuration 122 may be effected by controller 300. FIG. 6 provides an example where the at least one second configuration 122 may include combinations of configurations. For example, second configuration 122 may include opening pores P for a first level of heat transfer and adding ribs 216 if greater heat transfer is needed. Also, second configuration may include closing pores P to help make the article 115 more water resistant while retaining ribs 216.

With continued reference to FIG. 6, this example shows a representation where sensor 150 is detached from article 115. It will be understood that sensor 150 may be incorporated in the article 115 (FIG. 1) or provided remotely in a dedicated device or leveraged from a user device D as described above. Sensor 150 may include an audio sensor 220 including but not limited to a microphone that detects the sound of rain or wind and communicate this information to controller 300. This sensed information may be used to selectively reconfigure the article by closing pores P to make the article more wind or water resistant.

Sensor 150 may detect geographic location and be used by controller 300 to change a configuration based on the user's location or location relative to another object or person. For example, sensor 150 may detect user's location and report this location to controller 300, which is in communication with another individual's smart device, such as a parent or caregiver, such that if the user is more than a selected distance from the parent or caregiver smart device, controller 300 provides an activation command A effecting a change from a first configuration 121 to a second configuration 122, such as a color change, to make the user U more visible and assist the parent/caregiver in finding the user. Similar function could be performed by controller 300 based on the user's location relative to a defined location or path. Sensor 150 may have the ability to sense multiple conditions, and provide controller with a combination of sensed information that is used by controller 300 to provide an activation command.

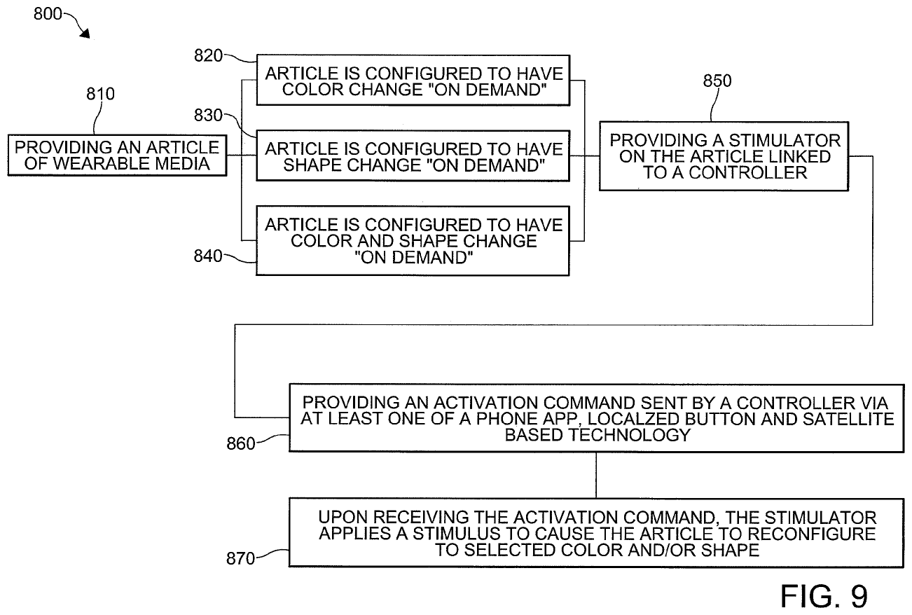

As an alternative or in addition to sensor 150, controller 300 may be in communication with a data store 400 (FIG. 9) that includes information that controller 300 may act on to send an activation command. The data store 400 may include weather or other information that is correlated based on a sensed position for user. In another example, multiple users U may register to allow controller 300 to control configuration of more than one user's wearable media 110 in contrast or coordination with each other based on instructions from the user or a third party. To perform registration, controller 300 may communicate with an authentication module 450 that stores a list of registered users in data store 400. Registration may include entering a SKU or other article information AI unique to a particular article 115 of wearable media to ensure proper access and control. In addition, authentication module may store user information UI associated with the article information, such as a unique identifier, password, and/or subscription information to facilitate access and control. As discussed more completely below, additional information including connected users or activity/event subscriptions may be added through authentication module and verified to permit third part control of a user's wearable media 110. For example, users U attending a sporting or entertainment event may register to permit controller to coordinate colors/shapes with other users to show unity for a particular team (user selection) or to allow the event host to change configurations based on the activity in the event (third party selection). In addition, subscriptions or pay per use services may be implemented at authentication module to allow users to subscribe to particular designers, fashion houses, retail outlets and other third party content providers that can deliver selected activation commands configured to cause an article to assume one or more configurations that offered by the content provider, as described more completely below.

With reference to FIG. 9, one example of a system 100 that provides the user with the option of multiparty reconfiguration. In this example, user U has at least one article that is capable of reconfiguration. This article is in communication with controller 300. In the example, controller 300 may include a number of “on demand” configurations accessible by user U. User may subscribe to these services through controller 300. The on demand service may include access to a data store 400 that stores at least one configuration in memory accessible by the user U as part of the subscription. In addition, user U may save their own custom configurations, purchased configurations, or preferred configurations, including but not limited to favorite colors, shapes, styles, performance configurations etc. to data store 400 via controller 300. Optionally, user U may designate friends, family, or other third party users TU that may access their saved configurations to allow coordination with the friends and family. Alternatively, user and third party users TU may register with controller 300 to allow controller to jointly control and coordinate the configuration of their respective articles. For example, user U and third party user TU may register with controller to allow joint control for purposes of coordinating their respective articles to show affiliation with a group, such as a family, team, etc. Alternatively, user U and third party user TU may permit coordination based on registration for an event, such as, attending a sporting event, fund raiser, entertainment event and the like. Such registration could combine designations such that a user U may register for an event and a show affiliation with a particular team at the event to allow joint control only in support of their team or display of team colors.

Controller 300 may also provide access to configurations from third party providers 420. Third party providers 420 may include manufacturers or retailers of articles or designs, designers or artists, activity specific configurations, or event specific configurations. Third party providers 420 would be in communication with controller 300 via a communication link 440 to provide activation commands for their designs, which would be stored in data store 400 and accessible by the user U based on their subscription, a purchase, or giveaway basis.

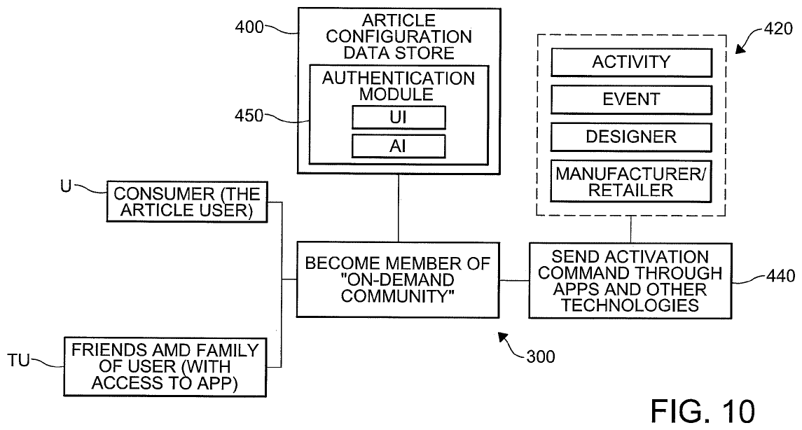

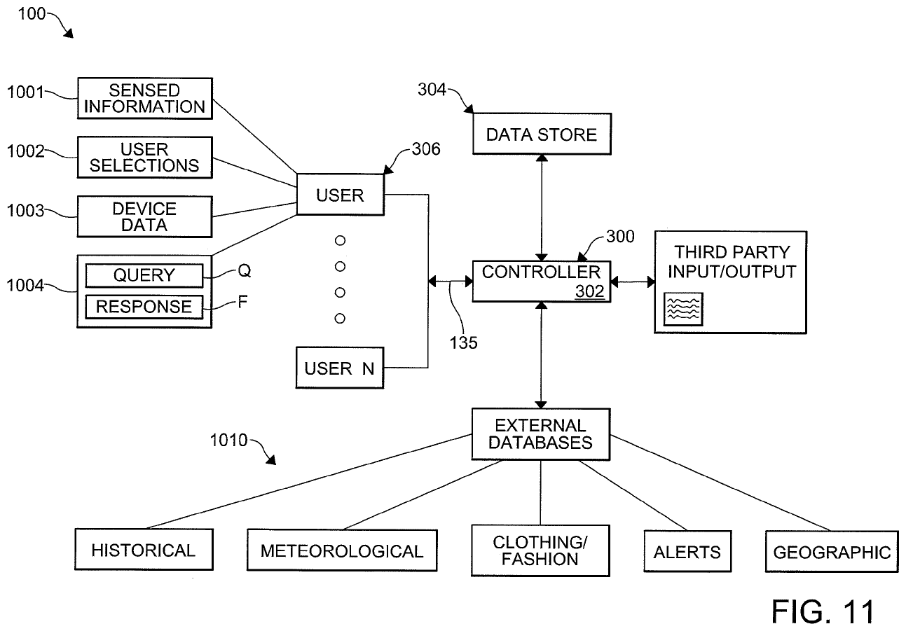

With reference to FIGS. 9 and 10, data store 400 may also store data related to one or more users. This data may be collected at input/output device 306, and be processed by processor 302 associated with controller 300 to develop trend information or other analytics based on sensor information 1001, user selections 1002, data from connected user device, referred to as device data 1003, or user input 1004. System 100 may provide access to or report user information to third parties through a third party input/output 1005. Third parties may include but not limited to retailers, designers, content providers, and health organizations. For example, user information including but not limited to the configurations selected by the user, the frequency that particular configurations are selected, the times when configurations are selected, the conditions correlated to the user selection including any information from sensor and/or how the sensed information correlates to a particular configuration or change of configuration. Controller 300 may process the user information collected in data store 304 to determine trends or identify particular configurations to be provided as primary configurations, or used to increase marketing activities based on their frequency of selection. Controller 300 may also analyze sensed information 1001 including but not limited to location, temperature, humidity, and user conditions, such as, body temperature, heart rate and the like and correlate this information to configuration changes. Such information may be analyzed by controller 300 to provide information on configuration effectiveness relative to sensed conditions. In one example, controller 300 is connected to multiple users and collects user information, sensed information and configuration information from multiple users in multiple locations. Using location information, controller 300 may map configurations selected by users to analyze geographically based trends. Such trend information may be used to adapt designs based on geographical trends including but not limited to design popularity and effectiveness.

With reference to FIG. 10, controller 300 may further augment user data by soliciting information from user. For example, controller 300 may direct a query Q to input/output device 306 and obtain an input from one or more users (User₁-User_{N}). The query Q may include but is not limited to a configuration query to inquire as to a user's preference for a particular configuration, or to determine if a user is attracted to or would consider purchasing additional article configuration. The user feedback F from query Q would be stored in data store 400. Controller 300 may analyze the user feedback in comparison to additional user feedback and further analyze the user feedback in the context of data available from connected data stores 1010. For example, controller 300 via a network connection may access external data store(s), generally indicated at 1010, that contain data regarding geographic information, meterological information, fashion trend information, alerts and historic trend information to analyze the feedback in the context of this information. Controller 300 may analyze the information to generate further queries and perform a machine learning process with the benefit of user input.

With reference to FIGS. 1A and 1B, an example is shown with a user U having an article 115 in communication with a controller 300 via a network N, such as a telecommunications network. In the example, user U has registered with controller 300 as described above and has a user device D that selectively communicates with controller 300 for instance via an application on the device D or other virtual network function accessible from the device D including but not limited to a dedicate website, automated call center, or the like. From the device D, user inputs a selected configuration for one or more articles 115. In the example shown, plural articles 115 (shirt and pants) are controlled. A selection signal S is transmitted to controller via network N in FIG. 1A. In FIG. 1B, controller 300 transmits one or more activation commands A to article(s) 115 via network N. As discussed previously, activation command is received on a communications link and transmitted to stimulator to effect the selected reconfiguration of article 115. In the example shown, each article 115 undergoes a color change in response to activation command A. FIGS. 2A and 2B show an example of a multi-user configuration. In this example, a first user U1 and a second user U2 are registered with controller 300 to permit coordination of their respective wearable media 110. In the example, first user U1 has wearable media in a first configuration 121 and second user U2 has articles in in a second configuration 122. The second configuration 122 differs from first configuration 121. While both users in the example may have wearable media 110 that can change configuration, the second user in this example may simply be wearing articles in a second configuration 122 that first user wishes to match.

In this example, first user U1 wishes to reconfigure the wearable media 110 to match second user U2. In the example, user has a controller 300 that communicates with the articles and selects the desired configuration using an input/output device on controller 300. In alternative examples described above, controller 300 may be remote from the users and accessed via a user device. Or if both users U1,U2 are registered, coordination of their wearable media may occur based on registration for an event or activity or other automatic delivery of coordinating activation commands. In the example, first user U1 selects a color change for a shirt and a pant to match the colors of second user's shirt and pants. Based on the selection, controller 300 provides the necessary activation command(s) to effect the change in configuration from first configuration 121 (FIG. 2A) to second configuration 122 (FIG. 2B). The depicted examples apply equally to shape change materials that allow the user U to select different textures or other physically defined configurations.

The following are additional examples of selective changes in configuration by controller 300 to one or more wearable media 110. Articles 115 having a color change capability may be changed via controller 300 to a second configuration to allow the article to match or coordinate with other articles worn by the same user. For example, article 115 may include shoes that are color changed to match a dress. The same shoe can change color again to match another dress with a different color. Likewise, for shape changing materials, article shape or texture may be controlled to customize the appearance of an outfit. For example, a single pair of shoes could undergo texture changes that provide the appearance fabric, suede or leather by reconfiguring the shoe texture. Texturing shape configurations can be used with any article. Therefore, the provided examples should not be considered limiting.

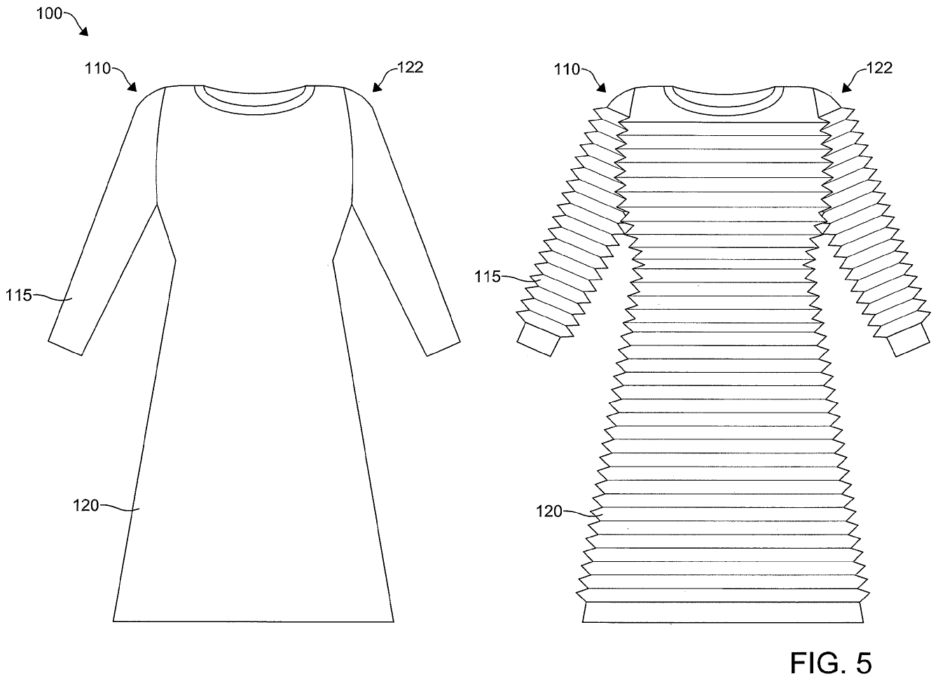

In addition to ornamental considerations, users may also want to change the look of an article 115 for performance reasons. For example, a user may change the texture either of the full jacket or part of the jacket to increase wear resistance or provide greater protection. Using a jacket as an example, a user may want to protect the elbow zones of the jacket, they can change the texture or stiffness of the elbow to be more protective, abrasion/tear resistant. In another example, a user may want to improve performance by changing the stiffness or shape of material to provide additional support or cushioning FIG. 5 shows one example where a portion 120 is provided in pants behind the knee K. Portion 120 may have a first configuration that conforms to the normal line of pants and a second configuration 122 that expands and or stiffens the portion 120 to provide support behind knee K. Controller 300 may be used to change product configuration to allow more flexible use of an article 115. For example, a user wants to wear jeans one day with a flared cut, but the next day wants it to be tapered. According to the examples herein, user could change between a flared configuration and a tapered configuration by sending an activation command through controller 300 that is programmed to execute instructions to provide the stimuli needed to effect this change. In other examples, the same garment or footwear can have texture of leather looking to fabric looking to metal looking with combination of shape/texture change and color change.

Combinations of color and shape/texture change can create unique combination that could provide a third party with access to controller 300 the ability to create custom clothing or release new designs that would be effected through article 110.

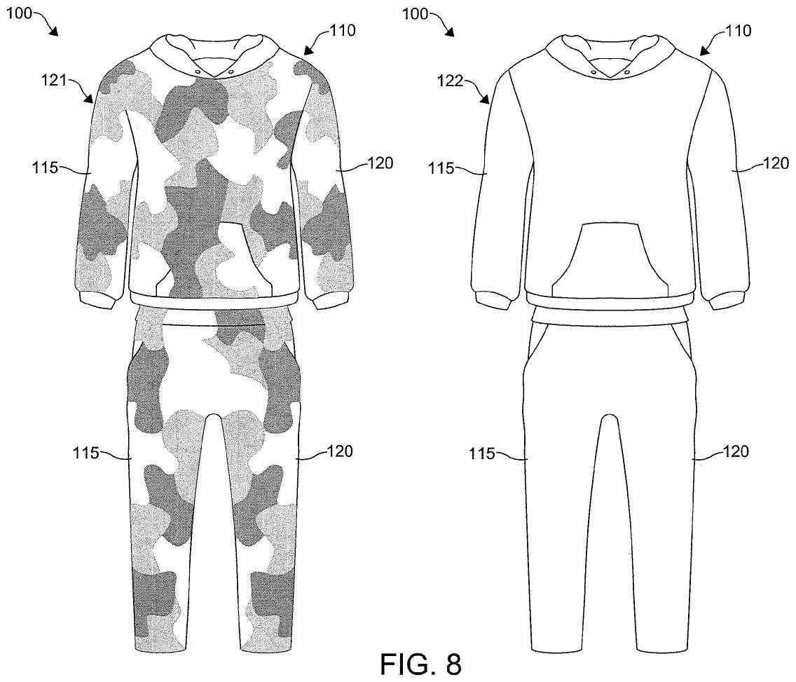

With reference to FIG. 8, system 100 may include a method for controlling wearable media generally indicated by the number 800 in FIG. 8. According to the method an article of wearable media capable of undergoing a change in configuration is provided at step 810. Article may be provided such that it is configured to change color, change shape, or change both shape and color on an on demand basis as indicated at steps 820,830,840. A stimulator is provided on article at step 850. A communication link between controller and stimulator is also established at 850. Controller provides an activation command corresponding to a selected configuration of the article to the stimulator at 860. At 870, upon receiving the activation command, the stimulator applies a stimulus to the portion of the article configured to perform at least one of a color and a shape change to reconfigure the article according to the activation command.

### EXAMPLES

### Example 1

A system for controlling wearable media, the system comprising: an article of wearable media, the article including at least one portion that is configured to change from a first configuration to a second configuration in response to a stimulus; a stimulator coupled to the at least one portion and adapted to selectively apply a stimulus upon receiving an activation command; a controller including a processor, a memory and an input/output device, the processor configured to execute instructions including communicating with the wearable media, the controller being adapted to selectively communicate with the stimulator to send the activation command to change the at least one portion from the first configuration to the second configuration.

### Example 2

The system of example 1, wherein the stimulator includes at least one of a heating element, an electrical element, and an actuator coupled to the at least one portion of the article.

### Example 3

The system of any one of examples 1-2, wherein the controller is remote from the article.

### Example 4

The system of any one of examples 1-3, wherein the controller includes an input/output device configured to receive a configuration selection corresponding to at least one of the first configuration and the second configuration, and wherein the controller is configured to provide the activation command corresponding to the configuration selection.

### Example 5

The system of any one of examples 1-4, further comprising an input device located remotely of the controller, the input device being in communication with the controller and adapted to provide a signal corresponding to selection of at least one of the first configuration and the second configuration, and wherein the controller is adapted to provide the activation command corresponding to the signal.

### Example 6

The system of example 5, wherein the input device includes a smart device.

### Example 7

The system of any one of examples 1-6, wherein the controller is in communication with a third party device.

### Example 8

The system of any one of examples 1-7, wherein the controller includes an authentication module, the authentication module adapted to communicate with at least one of a user device, a third party user device, and a third party device, the authentication module configured to establish a connection between the at least one of the user device, third party user device and third party device and the controller.

### Example 9

The system of example 8, wherein upon establishing a connection via the authentication module, the input/output device is configured to receive the activation command from the at least one of the user device, third party user device and third party device.

### Example 10

The system of any one of examples 1-9, wherein the first configuration includes a first color and the second configuration includes at least one second color different from the first color.

### Example 11

The system of any one of examples 1-10, wherein the first configuration includes a first shape and the second configuration includes a second shape different from the first shape.

### Example 12

The system of any one of examples 1-11, wherein the first configuration is a flat configuration and the second configuration includes an extended surface.

### Example 13

The system of example 12, wherein the extended surface is a rib.

### Example 14

The system of any one of examples 1-13, wherein the first configuration and second configuration include at least one pore in the article, and wherein in the first configuration, the at least one pore is closed and in a second configuration, the at least one pore is open.

### Example 15

The system of any one of examples 1-14, further comprising a sensor in communication with the controller, the sensor providing condition information, and wherein the controller is adapted to change the at least one portion of the article to at least one of the first configuration and the second configuration based on the condition information.

### Example 16

The system of example 15, wherein the sensor is configured to detect at least one of a temperature, a humidity, a pressure, a location, a user body temperature, a pollen level, and a toxin.

### Example 17

The network device of any one of examples 1-16, wherein the at least a portion of the article is constructed from at least one of a at least one of a fabric dyed with an electrophoretic or electric ink; a fabric dyed with a thermoschromatic ink; a photonic bandgap fiber; a shape memory polymer, a smart polymer; a Nitinol fiber; a smart material comprising at least one of a carbon fiber, carbon nanotube, a carbon powder and a nickel powder; a fabric coated with a first coating material and a second coating material where the first and second coating material have different thermal expansion properties; polyurethanes, polyurethanes with an ionic or a mesogenic component; a block copolymer of polyethylene terephthalate and polyethyleneoxide; a block copolymer of a polystyrene and poly(1,4-butadiene) and an ABA triblock copolymer made from poly(2-methyl-2-oxazoline) and polytetrahydrofuran; linear, amorphous polynorbornene; a hybrid polymer having a polynorbornene that is partially substituted by polyhedral oligosilsesquioxane; and a light activated polymer having a cinnamic group.

### Example 18

A network device comprising: a processor, an input/output device coupled to the processor, and a memory coupled with the processor, the memory comprising executable instructions that when executed by the processor cause the process to effectuate operations comprising:

creating a data store including at least one activation command configured to change at least a portion of wearable media from a first configuration to a second configuration;

providing an authentication module for at least one of a user, a third party user, and a third party provider to provide selected access to the at least one activation command in the data store.

### Example 19

The network device of example 18, further comprising: communicating the at least one activation command to the at least a portion of the wearable media for at least one of a user and a third party user.

### Example 20

The network device of any one of examples 18-19, further comprising: uploading at least one activation code corresponding to a selected configuration from a third party provider.

### Example 21

The network device of any one of examples 18-20, wherein the authentication module provides access to a selected activation command in the data store based on user information stored in the data store.

### Example 22

The network device of any one of examples 18-21, wherein the authentication module stores a coordination authorization connecting the user with the third party user; and wherein the processor sends the activation command to the user and the third party user to coordinate the configuration of at least a portion of wearable media worn by the user and at least a portion of wearable media worn by the third party user.

### Example 23

The network device of any one of examples 18-22, further comprising communicating a third party activation command at least a portion of an article of wearable media owned by the user.

### Example 24

A system for controlling wearable media, the system comprising:

an article of wearable media, the article including at least one portion that is constructed from at least one of a color change material and a shape memory material, wherein the at least one portion is configured to change from a first configuration to a second configuration in response to a stimulus; a stimulator coupled to the at least one portion and adapted to selectively apply a stimulus upon receiving an activation command; a controller including a processor, a memory and an input/output device, the processor configured to execute instructions including communicating with the wearable media, the controller being adapted to selectively communicate with the stimulator to send the activation command to change the at least one portion from the first configuration to the second configuration; a sensor in communication with the controller, wherein the controller is configured to send the activation command based on a signal from at least one of the input/output device and the sensor.

### Example 25

A system for controlling wearable media comprising a controller in communication with at least one article of wearable media that has at least a portion constructed of a material that changes configuration in response to a stimulation, the controller is further in communication with an input/output device and a data store, wherein the input/output device obtains a user input relating to selected configurations of the at least a portion of the article and the controller stores the data in the data store.

### Example 26

The system of example 25, wherein the controller analyzes the data obtained from the user input to develop trend data.

### Example 27

The system of any one of examples 25-26, wherein the controller is in communication with a third party configuration provider, wherein the controller selectively reports the trend data to the third party configuration provider.

### Example 28

The system of any one of examples 25-27, wherein the controller receives at least one configuration from the third party configuration provider and stores an activation command corresponding to the at least one configuration in the data store.

### Example 29

The system or example 28, wherein the controller transmits the activation command corresponding to the at least one configuration to a stimulator associated with the article to place the article in the configuration.

### Example 30

The system of example 26, wherein based on the trend data controller prompts a third party input/output device to modify advertising for a selected configuration.

### Example 31

The system of example 30, wherein the step of modifying advertising includes at least one of increasing a frequency of advertising for a selected configuration, providing advertising for a selected configuration in a selected geographic area, and recommending a configuration to a selected user.

### Example 32

The system of example 24 or 25, wherein the controller provides a query to a user input/output to obtain feedback.

### Example 33

The system of example 32, wherein the controller analyzes the feedback and updates the data store, and provides successive queries as needed to continue an analysis, wherein the data store is updated with each query and analysis.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

1. A system for controlling wearable media, the system comprising:
an article of wearable media, the article including at least one portion that is configured to change from a first configuration to a second configuration in response to a stimulus, wherein the first configuration comprises a first color and the second configuration comprises at least one second color different from the first color;
a stimulator coupled to the at least one portion and adapted to selectively apply the stimulus upon receiving an activation command;
a controller including a processor, a memory and an input/output device, the processor configured to execute instructions including communicating with the wearable media, the controller being adapted to selectively communicate with the stimulator to send the activation command to change the at least one portion from the first configuration to the second configuration.

2. The system of claim 1, wherein the stimulator comprises at least one of a heating element, an electrical element, and an actuator coupled to the at least one portion of the article.

3. The system of claim 1, wherein the controller comprises an input/output device configured to receive a configuration selection corresponding to at least one of the first configuration and the second configuration, and wherein the controller is configured to provide the activation command corresponding to the configuration selection.

4. The system of claim 3, wherein the input/output device comprises a smart device.

5. The system of claim 1, wherein the controller comprises an authentication module, the authentication module adapted to communicate with at least one of a user device, a third party user device, and a third party device, the authentication module configured to establish a connection between the at least one of the user device, third party user device and third party device and the controller.

6. The system of claim 5, wherein upon establishing a connection via the authentication module, the input/output device is configured to receive the activation command from the at least one of the user device, third party user device and third party device.

7. The system of claim 1, wherein the first configuration comprises a first color stiffness and the second configuration comprises a second stiffness different from the first stiffness.

8. The system of claim 1, wherein the first configuration comprises a first shape and the second configuration comprises a second shape different from the first shape.

9. The system of claim 8, wherein the first shape is a flat configuration and the second shape comprises an extended surface.

10. The system of claim 1, wherein the first configuration and second configuration include at least one pore in the article, and wherein in the first configuration, the at least one pore is closed and in a second configuration, the at least one pore is open.

11. The system of claim 1, further comprising a sensor in communication with the controller, the sensor providing condition information, and wherein the controller is adapted to change the at least one portion of the article to at least one of the first configuration and the second configuration based on the condition information.

12. The system of claim 1, wherein the sensor is configured to detect at least one of a temperature, a humidity, a pressure, a location, a user body temperature, a pollen level, and a toxin.

13. The system of claim 1, wherein the at least a portion of the article is constructed from at least one of a at least one of a fabric dyed with an electrophoretic or electric ink; a fabric dyed with a thermoschromatic ink; a photonic bandgap fiber; a shape memory polymer, a smart polymer; a Nitinol fiber; a smart material comprising at least one of a carbon fiber, carbon nanotube, a carbon powder and a nickel powder; a fabric coated with a first coating material and a second coating material where the first and second coating material have different thermal expansion properties; polyurethanes, polyurethanes with an ionic or a mesogenic component; a block copolymer of polyethylene terephthalate and polyethyleneoxide; a block copolymer of a polystyrene and poly(1,4-butadiene) and an ABA triblock copolymer made from poly(2-methyl-2-oxazoline) and polytetrahydrofuran; linear, amorphous polynorbornene; a hybrid polymer having a polynorbornene that is partially substituted by polyhedral oligosilsesquioxane; and a light activated polymer having a cinnamic group.

14. A system for controlling wearable media, the system comprising:
an article of wearable media, the article including at least one portion that is constructed from at least one of a color change material or a shape memory material, wherein the at least one portion is configured to change from a first configuration to a second configuration in response to a stimulus, wherein the first configuration comprises a first aesthetic appearance and the second configuration comprises a second aesthetic appearance different from the first aesthetic appearance; a stimulator coupled to the at least one portion and adapted to selectively apply a stimulus upon receiving an activation command;
a controller including a processor, a memory and an input/output device, the processor configured to execute instructions including communicating with the wearable media, the controller being adapted to selectively communicate with the stimulator to send the activation command to change the at least one portion from the first configuration to the second configuration;
a sensor in communication with the controller,
wherein the controller is configured to send the activation command based on a signal from at least one of the input/output device and the sensor.

15. A network device comprising: a processor, an input/output device coupled to the processor, and a memory coupled with the processor, the memory comprising executable instructions that when executed by the processor cause the process to effectuate operations comprising:
creating a data store including at least one activation command configured to change at least a portion of wearable media from a first configuration to a second configuration; and
providing an authentication module for at least one of a user, a third party user, and a third party provider to provide selected access to the at least one activation command in the data store.

16. The network device of claim 15 further comprising: communicating the at least one activation command to the at least a portion of the wearable media for at least one of a user and a third party user.

17. The network device of claim 15, further comprising: uploading at least one activation code corresponding to a selected configuration from a third party provider.

18. The network device of claim 15, wherein the authentication module provides access to a selected activation command in the data store based on user information stored in the data store.

19. The network device of claim 15, wherein the authentication module stores a coordination authorization connecting the user with the third party user; and wherein the processor sends the activation command to the user and the third party user to coordinate the configuration of at least a portion of wearable media worn by the user and at least a portion of wearable media worn by the third party user.

20. The network device of claim 15, further comprising communicating a third party activation command at least a portion of an article of wearable media owned by the user.
